(19) United States
(12) Patent Application Publication
(10) Pub. No.: US 2026/0343668 A1
(43) Pub. Date: Oct. 29, 2026

(54) DECOUPLED DOWNLINK AND UPLINK POWER ADAPTATION

(71) Applicant: QUALCOMM Incorporated, San Diego, CA (US)

(72) Inventors: Wooseok NAM, San Diego, CA (US); Mostafa KHOSHNEVISAN, San Diego, CA (US); Tao LUO, San Diego, CA (US); Junyi LI, Greentown, PA (US); Xiaoxia ZHANG, San Diego, CA (US)

(21) Appl. No.: 19/189,770

(22) Filed: Apr. 25, 2025

(51) Int. Cl. H04W 76/28; H04W 72/1263; H04W 72/25

(52) U.S. Cl. CPC H04W 76/28; H04W 72/1263; H04W 72/25

(57) ABSTRACT

This disclosure provides methods, components, devices and systems for decoupled downlink and uplink power adaptation. For example, a UE may be configured with parameters for a discontinuous reception (DRX) cycle and a discontinuous transmission (DTX) cycle. The UE may monitor for DCI that schedules downlink signaling according to DRX parameters and timers and for DCI that schedules uplink signaling according to DTX parameters and timers. In some examples, a dormant downlink and uplink secondary cells may be separately configured for the UE. In some examples, the UE may be indicated to only skip monitoring a physical downlink control channel (PDCCH) for downlink DCI or to only skip monitoring PDCCH for uplink DCI.

### TECHNICAL FIELD

This disclosure relates generally to wireless communication, and more specifically to systems, devices, methods, and techniques associated with decoupled downlink and uplink power adaptation.

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving control signaling that indicates a configuration that separately configures discontinuous reception (DRX) operation and discontinuous transmission (DTX) operation, the configuration indicating a set of DRX parameters for the DRX operation and a set of DTX parameters for the DTX operation, monitoring for downlink control information that schedules a downlink communication in accordance with the set of DRX parameters for the DRX operation, and monitoring for downlink control information that schedules an uplink communication in accordance with the set of DTX parameters for the DTX operation.

A UE for wireless communications is described. The UE may include a processing system that includes processor circuitry and memory circuitry that stores code. The processing system may be configured to cause the UE to receive control signaling that indicates a configuration that separately configures DRX operation and DTX operation, the configuration indicating a set of DRX parameters for the DRX operation and a set of DTX parameters for the DTX operation, monitor for downlink control information that schedules a downlink communication in accordance with the set of DRX parameters for the DRX operation, and monitor for downlink control information that schedules an uplink communication in accordance with the set of DTX parameters for the DTX operation.

Another UE for wireless communications is described. The UE may include means for receiving control signaling that indicates a configuration that separately configures DRX operation and DTX operation, the configuration indicating a set of DRX parameters for the DRX operation and a set of DTX parameters for the DTX operation, means for monitoring for downlink control information that schedules a downlink communication in accordance with the set of DRX parameters for the DRX operation, and means for monitoring for downlink control information that schedules an uplink communication in accordance with the set of DTX parameters for the DTX operation.

A non-transitory computer-readable medium storing code for wireless communications is described. The code may include instructions executable by one or more processors to receive control signaling that indicates a configuration that separately configures DRX operation and DTX operation, the configuration indicating a set of DRX parameters for the DRX operation and a set of DTX parameters for the DTX operation, monitor for downlink control information that schedules a downlink communication in accordance with the set of DRX parameters for the DRX operation, and monitor for downlink control information that schedules an uplink communication in accordance with the set of DTX parameters for the DTX operation.

In some examples of the method, UEs, and non-transitory computer-readable medium described herein, the configuration indicates that starting or restarting of one or more DRX timers may be independent of reception of the first downlink control information that schedules the uplink transmission.

A method for wireless communications by a network entity is described. The method may include outputting control signaling that indicates a configuration that separately configures DRX operation and DTX operation for a UE, the configuration indicating a set of DRX parameters for the DRX operation and a set of DTX parameters for the DTX operation, outputting downlink control information that schedules the UE for downlink communications in accordance with the set of DRX parameters for the DRX operation, and outputting downlink control information that schedules the UE for uplink communications in accordance with the set of DTX parameters for the DTX operation.

A network entity for wireless communications is described. The network entity may include a processing system that includes processor circuitry and memory circuitry that stores code. The processing system may be configured to cause the network entity to output control signaling that indicates a configuration that separately configures DRX operation and DTX operation for a UE, the configuration indicating a set of DRX parameters for the DRX operation and a set of DTX parameters for the DTX operation, output downlink control information that schedules the UE for downlink communications in accordance with the set of DRX parameters for the DRX operation, and output downlink control information that schedules the UE for uplink communications in accordance with the set of DTX parameters for the DTX operation.

Another network entity for wireless communications is described. The network entity may include means for outputting control signaling that indicates a configuration that separately configures DRX operation and DTX operation for a UE, the configuration indicating a set of DRX parameters for the DRX operation and a set of DTX parameters for the DTX operation, means for outputting downlink control information that schedules the UE for downlink communications in accordance with the set of DRX parameters for the DRX operation, and means for outputting downlink control information that schedules the UE for uplink communications in accordance with the set of DTX parameters for the DTX operation.

A non-transitory computer-readable medium storing code for wireless communications is described. The code may include instructions executable by one or more processors to output control signaling that indicates a configuration that separately configures DRX operation and DTX operation for a UE, the configuration indicating a set of DRX parameters for the DRX operation and a set of DTX parameters for the DTX operation, output downlink control information that schedules the UE for downlink communications in accordance with the set of DRX parameters for the DRX operation, and output downlink control information that schedules the UE for uplink communications in accordance with the set of DTX parameters for the DTX operation.

### BRIEF DESCRIPTION OF THE DRAWINGS

FIG. 1 shows an example of a wireless communication system.

FIG. 2 shows an example of a signaling diagram that supports decoupled downlink and uplink power adaptation.

FIG. 3 shows an example of a process flow that supports decoupled downlink and uplink power adaptation.

FIG. 4 shows a block diagram of a processing system that supports decoupled downlink and uplink power adaptation.

FIG. 5 shows a diagram of a system including a device that supports decoupled downlink and uplink power adaptation.

FIG. 6 shows a block diagram of a processing system that supports decoupled downlink and uplink power adaptation.

FIG. 7 shows a diagram of a system including a device that supports decoupled downlink and uplink power adaptation.

FIGS. 8 through 10 show flowcharts illustrating methods that support decoupled downlink and uplink power adaptation.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

A wireless communications system may support various techniques to reduce power consumption at a user equipment (UE). For example, a UE may operate according to a discontinuous reception (DRX) cycle, be configured with a dormant secondary cell, or be configured to skip monitoring for control signaling. In some cases, configurations for these power savings techniques prevent the UE from performing both downlink communications and uplink communications, such that downlink power adaptation techniques and uplink power adaptation techniques are coupled together. For example, a UE that operates according to a DRX cycle may not monitor for any downlink control information (DCI) and may be unable to transmit some uplink signaling (e.g., channel state information (CSI) reports or sounding reference signals (SRSs), preventing the UE from receiving downlink signaling or transmitting uplink signaling. Some wireless communications systems may support decoupled downlink and uplink operation modes. However, a UE that is configured to perform power savings techniques which apply to both downlink and uplink communications may not be able to efficiently use decoupled downlink and uplink operation.

Aspects of the subject matter described in this disclosure relate to decoupled power adaptation techniques for uplink and downlink communications. For example, a UE may be configured with parameters for a DRX cycle and a discontinuous transmission (DTX) cycle. The UE may monitor for DCI that schedules downlink signaling according to the parameters for the DRX cycle, and the UE may monitor for DCI that schedules uplink signaling according to the parameters for the DTX cycle. In some examples, a dormant downlink secondary cell and a dormant uplink secondary cell may be separately configured for the UE. For example, the UE may receive downlink signaling via a downlink cell while an uplink cell of the UE is dormant, or the UE may transmit uplink signaling via an uplink cell while a downlink cell of the UE is dormant. In some examples, the UE may be indicated to only skip monitoring a physical downlink control channel (PDCCH) for downlink DCI or to only skip monitoring PDCCH for uplink DCI.

Particular aspects of the subject matter described in this disclosure can be implemented to realize one or more of the following potential advantages. In some examples, by configuring a UE with decoupled uplink and downlink power savings configurations, the described techniques can be used to improve power savings gains and improve throughput. For example, by configuring a UE with a DRX cycle and a DTX cycle, the UE may reduce power consumption by performing a reduced quantity of blind decodings, for example searching for DCI that schedules uplink signaling in an on duration of the DTX cycle.

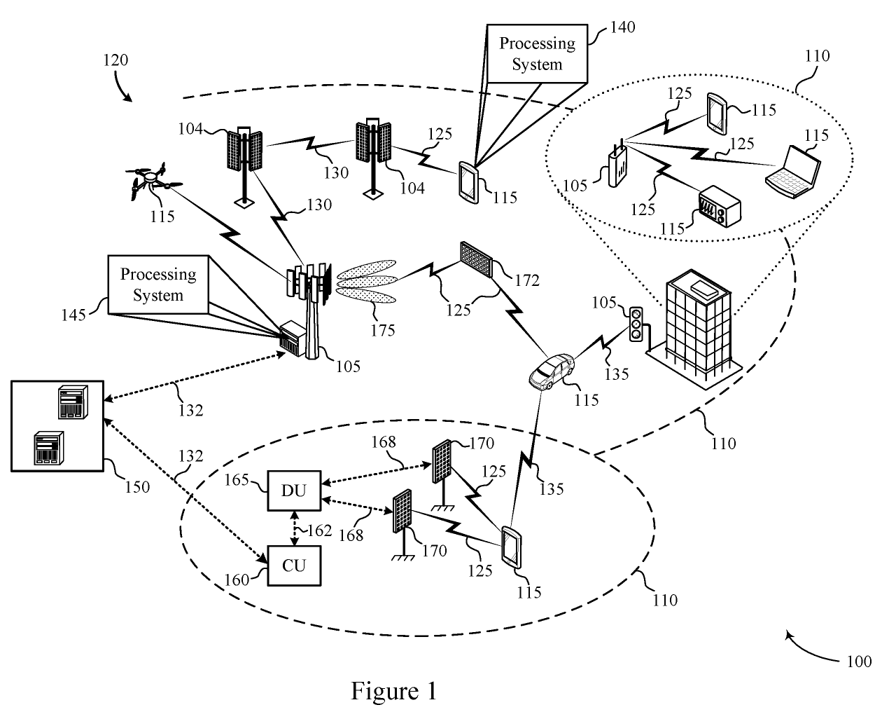

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

The wireless communication system 100 may support techniques to reduce power consumption at a UE 115. For example, a UE 115 may be configured to operate according to a DRX cycle. In some wireless communication systems, a UE 115 configured to operate according to a DRX cycle may not perform uplink or downlink signaling outside of a DRX active time (e.g., while an on duration timer, an inactivity timer, or a retransmission timer for a DRX cycle are active). For example, the UE 115 of these systems may not monitor a physical downlink control channel (PDCCH), report periodic CSI or semi-periodic CSI, or transmit periodic SRS or semi-periodic SRS. In some wireless communication systems, a UE 115 may be configured for secondary cell dormancy. On a dormant bandwidth part configured for secondary cell dormancy, the UE 115 may not be able to monitor a PDCCH, receive physical downlink shared channel (PDSCH) signaling, report CSI, transmit SRS, transmit physical uplink control channel (PUCCH) signaling, transmit physical uplink shared channel (PUSCH) signaling, or transmit random access (e.g., random access channel (RACH)) signaling. In some wireless communication systems, a UE 115 may be configured to perform PDCCH skipping. When configured for PDCCH skipping, the UE may not monitor PDCCH signaling during a PDCCH skipping duration for DCI that schedules uplink signaling or downlink signaling. In some examples, power savings techniques may be referred to as power adaptation techniques.

A power-efficient device architecture may include segmentation of hardware blocks and sub-systems. The segmentation of the hardware blocks and sub-systems may be based on different characteristics or functionalities. For example, analog and digital blocks may be segmented and separately controllable. Additionally, or alternatively, downlink reception and uplink transmission blocks may be segmented, or processing blocks for control channels, data channels, and channel measurement may be segmented, among other examples. Each block may be separately controllable, for example turned on or off by power gating or islanding when a block is not being used.

A power-efficient device architecture may be supported by, and jointly optimized with, power saving mode operations. For example, a network entity 105 may indicate for a UE 115 to turn off a PDCCH processing block by transmitting a PDCCH skipping indication to the UE 115. In some systems, power saving schemes may be coupled to affect both downlink communications and uplink communications. For example, a UE 115 that is configured to operate according to a DRX cycle in these systems may be unable to receive downlink signaling or transmit uplink signaling outside of the active time of the DRX cycle.

Some wireless communication systems, such as the wireless communication system 100, may support decoupled downlink and uplink operation modes. For example, a UE 115 may be configured with an uplink-only component carrier or be served by a transmission and reception point (TRP) only for uplink communications. Additionally, or alternatively, downlink communications and uplink communications for a UE 115 may have separate beam management (e.g., uplink beams may be configured or maintained separately from downlink beams). Thus, current techniques for power savings which couple together uplink power savings with downlink power savings may be inefficient for a UE 115 that supports decoupled uplink and downlink operation.

The wireless communication system 100 may support techniques for decoupled uplink and downlink power adaptation at a UE 115. In some examples, a network entity 105 may configure the UE 115 with a configuration for a DRX cycle and a separate configuration for a DTX cycle. The DTX cycle, and the DRX cycle, may periodically alternate between an on duration (e.g., an active duration) where one or more operations may be performed (e.g., transmit or receive), and an off duration where the UE 115 may enter a lower power state (e.g., may not transmit or receive). In an example, the DRX cycle and the DTX cycle may have separate parameters or timers, or both. In some cases, the on duration of DTX cycle may be completely non-overlapping in time relative to on duration of the DRX cycle. In other cases, the on duration of DTX cycle may partially or completely overlap in time with the on duration of the DRX cycle. The DTX cycle may be triggered (e.g., controlled) by DCI that schedules uplink signaling, and the DRX cycle may be triggered (e.g., controlled) by DCI that schedules downlink signaling. While the DTX cycle is active and the DRX cycle is inactive, the UE 115 may monitor for DCI that schedules the UE 115 for uplink signaling. For example, while the DTX cycle is active and the DRX cycle is inactive, the UE may not monitor for DCI that schedules the UE 115 for downlink signaling, such as by not attempting to decode DCI having a DCI format that schedules downlink signaling or by not performing blind decodings to obtain DCI that schedules downlink signaling.

In some examples, the wireless communication system 100 may support decoupled secondary cell dormancy techniques, such as configuring a UE 115 for dormant uplink bandwidth parts and dormant downlink bandwidth parts separately. On an uplink dormant bandwidth part, uplink-related restrictions may be applied. For example, the UE 115 may be unable to report CSI or transmit SRS, PUCCH, PUSCH, or RACH signaling on the uplink dormant bandwidth part. On a downlink dormant bandwidth part, downlink-related restrictions may be applied. For example, the UE 115 may not be able to monitor PDCCH or receive PDSCH on the downlink dormant bandwidth part.

In some examples, the wireless communication system 100 may support decoupled PDCCH monitoring adaptation. For example, a network entity 105 may transmit DCI that configures a UE 115 to skip monitoring for DCI that schedules uplink signaling or DCI that schedules downlink signaling, or both, for a certain duration. Additionally, or alternatively, downlink PDCCH search space sets and uplink PDCCH search space sets may be decoupled, and search space set group switching may be separately applied to downlink and uplink search space set group switching.

Devices of the wireless communication system 100 may be configured to support one or more aspects of the described techniques for decoupled downlink and uplink power adaptation. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support techniques for decoupling downlink and uplink power adaptation mechanisms, allowing each channel to be optimized independently based on channel conditions and device requirements. This may provide reduced overall power consumption.

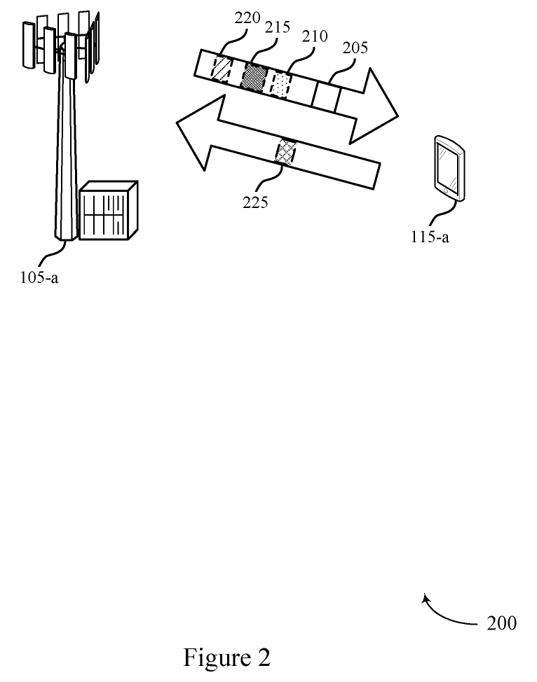

FIG. 2 shows an example of a signaling diagram 200 that supports decoupled downlink and uplink power adaptation. The signaling diagram 200 may implement aspects of a wireless communication system 100. For example, the signaling diagram 200 may include a UE 115-a and a network entity 105-a, which may be respective examples of a UE 115 and a network entity 105 described herein.

The UE 115-a may support techniques for decoupled uplink and downlink operation modes. For example, the UE 115-a or the network entity 105-a, or both, may perform beam management for uplink communications and downlink communication separately. In some examples, the UE 115-a may be configured with separate component carriers for uplink communications and downlink communications. For example, the UE 115-a may be configured with a component carrier that is configured only for uplink communications, or the UE 115-a may be served by a TRP (e.g., a network entity 105 such as the network entity 105-a) for uplink communications only, or both.

The network entity 105-a may transmit control signaling 205 indicating one or more power savings configurations to the UE 115-a. The control signaling 205 may indicate one or more configurations for downlink power adaptation or uplink power adaptation, or both. For example, the UE 115-a may perform procedures for uplink power adaptation, or uplink power savings techniques, that are decoupled from procedures for downlink power adaptation, or downlink power savings techniques.

In some examples, the UE 115-a may be configured for decoupled DRX and DTX operation. For example, the control signaling 205 may indicate configuration information for DRX operation, or for the UE 115-a to operate according to a DRX cycle. Additionally, or alternatively, the control signaling 205 may indicate configuration information for DTX operation, or for the UE 115-a to operate according to a DTX cycle. The configuration information for DTX operation may include a DTX on duration timer (e.g., dtx-onDurationTimer), a DTX inactivity timer (e.g., dtx-InactivityTimer), a DTX retransmission timer for uplink (e.g., dtx-RetransmissionTimerUL), a DTX round-trip time (RTT) timer or DTX hybrid automatic repeat request (HARQ) RTT timer (e.g., dtx-HARQ-RTT-TimerUL), or any combination thereof. The configuration information for DRX operation may include a DRX on duration timer (e.g., drx-OnDurationTimer), a DRX inactivity timer (e.g., drx-InactivityTimer), a DRX retransmission timer for downlink (e.g., drx-InactivityTimerDL), a DRX HARQ RTT timer (e.g., drx-HARQ-RTT-TimerDL), or any combination thereof. The configuration information for DTX duration may indicate values that correspond to durations for the one or more DTX timers.

In some examples, at least a portion of the DRX configuration information and DTX configuration information may be separate or different. For example, the DRX on duration timer may be different (e.g., have a different duration) than the DTX on duration timer. In some examples, the DRX configuration information and the DTX configuration information may be indicated by separate fields of a control signal (e.g., an RRC configuration message or RRC reconfiguration message). In some examples, some configurations or parameters may be shared between a DRX configuration and a DTX configuration. For example, a DRX configuration and a DTX configuration may have a same periodicity, offset, short cycle timer, or any combination thereof.

In some examples, the DTX timers may be triggered, or controlled, or both, by DCI that schedules uplink signaling, such as an uplink DCI 220. Downlink control information that schedules uplink signaling, such as an uplink transmission 225, may be referred to as uplink DCI. For example, the UE 115-a may start or restart a DTX inactivity timer if the UE 115-a receives the uplink DCI 220. In some examples, a DTX inactivity timer may be started or restarted by uplink DCI that indicates a new uplink transmission on a serving cell in a DTX group. Additionally, or alternatively, a DTX RTT timer or a DTX retransmission timer, or both, may be started by the uplink DCI 220.

If the UE 115-a is configured to operate according to a DRX cycle and a DTX cycle, DRX cycle operation for the UE 115-a may be different from DRX cycle operation of other systems. For example, the UE 115-a may not start or restart a DRX inactivity timer if the UE 115-a receives the uplink DCI 220. The UE 115-a may start or restart the DRX inactivity timer if the UE 115-a receives a downlink DCI 210, or DCI that schedules the UE 115-a for a downlink transmission 215. In some examples, the downlink DCI 210 may instruct the UE 115-a to start or restart a DRX downlink RTT, a retransmission timer, or both, but not by the uplink DCI 220. In some examples, the UE 115-a may not use (e.g., may not be configured with or may not operate according to) a DRX uplink RTT timer or a DRX uplink retransmission timer. For example, the UE 115-a may instead operate according to a DTX RTT timer, or a DTX retransmission timer, or both, instead of the DRX uplink RTT timer or the DRX uplink retransmission timer.

In some examples, DTX configuration may be applied for sidelink communications. For example, the UE 115-a may perform sidelink communication in accordance with the DTX configuration. The UE 115-a may communicate (e.g., transmit or receive) sidelink control information or downlink control information that schedules sidelink communications according to the timers of the DTX configuration. In some other examples, the control signaling 205 may indicate parameters for a sidelink DTX configuration. For example, the control signaling 205 may indicate respective DTX timers and parameters for Uu communications and sidelink communications. For example, separate DTX timers, separate parameters, or both, may be configured for Uu communications and sidelink communications, that each may be different.

For example, the control signaling 205 may indicate a DRX configuration and a DTX configuration to the UE 115-a. The DRX configuration may include durations of DRX timers and parameters for the DRX configuration, and the DTX configuration may include durations of DTX timers and parameters for the DRX configuration. The UE 115-a may monitor for downlink DCI (e.g., DCI that schedules the UE 115-a for downlink signaling) according to a DRX cycle of the DRX configuration, and the UE 115-a may monitor for uplink DCI (e.g., DCI that schedules the UE 115-a for uplink signaling) according to a DTX cycle of the DTX configuration. For example, the UE 115-a may monitor for downlink DCI while an on duration timer of the DRX cycle is active, and receipt of downlink DCI (e.g., the downlink DCI 210) may start or restart other DRX timers (e.g., a DRX inactivity timer, DRX downlink RTT timer, DRX downlink retransmission timer, or any combination thereof). In some examples, the UE 115-a receiving uplink DCI (e.g., the uplink DCI 220) while the on duration timer of the DRX cycle is active may not affect (e.g., start, restart, or end) DRX timers.

The UE 115-a may monitor for uplink DCI while an on duration timer of the DTX cycle is active. For example, receipt of the uplink DCI 220 may start or restart a DTX inactivity timer, a DTX RTT timer, or a DTX retransmission timer, or any combination thereof. In some examples, the UE 115-a receiving downlink DCI (e.g., the downlink DCI 210) while the on duration timer of the DTX cycle is active may not affect (e.g., start, restart, or end) DTX timers.

In some examples, the control signaling 205 may configure the UE 115-a for decoupled downlink and uplink secondary cell dormancy. For example, an active secondary cell uplink BWP switching to an uplink dormant BWP may be decoupled from that of the downlink BWP, even for a TDD scenario. On an uplink dormant BWP, legacy uplink-related restrictions may only be applied. For example, the UE 115-a may not report CSI or transmit SRS, PUCCH signaling, PUSCH signaling, or RACH signaling, or any combination thereof. On a downlink dormant BWP, legacy downlink-related restrictions may only be applied. For example, the UE 115-a may not monitor for PDCCH signaling or receive PDSCH signaling, or both. When decoupled downlink and uplink secondary cell dormancy is configured or supported, dormant secondary cell groups may be separately configured for downlink and uplink.

In some examples, the network entity 105-a may transmit control information to trigger the UE 115-a to switch to a downlink dormant BWP. For example, the network entity 105-a may use scheduling downlink DCI formats (e.g., DCI Format 1_1 or DCI Format 1_3) with uplink dormant secondary cell group indicator fields to indicate for the UE 115-a to switch to a downlink dormant BWP. Additionally, or alternatively, non-scheduling DCI formats (e.g., DCI Format 1_1 or DCI Format 1_3) with repurposed fields (e.g., corresponding to the primary cell or the primary secondary cell) to trigger the UE 115-a to switch to a downlink dormant BWP. In some examples, uplink DCI formats (e.g., DCI Format 0_1 or DCI Format 0_3) may be used to indicate for the UE 115-a to switch to a downlink dormant BWP.

In some examples, the network entity 105-a may transmit control information to trigger the UE 115-b to switch to an uplink dormant BWP. For example, the UE 115-b may be configured to switch to the uplink dormant BWP at least within an active time of a DRX cycle. The control information that triggers the UE 115-b to switch to the uplink dormant BWP may have an uplink scheduling DCI format (e.g., DCI Format 0_1, DCI Format 0_3) with a downlink dormant secondary cell group indicator field or a non-scheduling DCI format (e.g., DCI Format 0_1 or DCI Format 0_3) with repurposed fields (e.g., in the primary cell or primary secondary cell) to trigger the UE 115-b to switch to the uplink dormant BWP. In some examples, downlink DCI (e.g., DCI Format 1_1 or DCI Format 1_3) may be used to trigger the UE 115-a to switch to an uplink dormant BWP.

In some examples, the UE 115-a may be triggered to switch to an uplink or downlink dormant BWP, or both, via a wake-up signal (WUS). For example, the network entity 105-a may transmit a WUS (e.g., DCI with a cyclic redundancy check (CRC) scrambled by a power saving radio network temporary identifier (PS-RNTI), Downlink Control Information of Power Saving (DCP), or DCI Format 2_6) to trigger the UE 115-b to switch to an uplink dormant BWP or a downlink dormant BWP, or both. In some examples, a WUS may be used to trigger secondary cell dormancy outside of a DRX active time, for example while the UE 115-a is not monitoring for some PDCCH signaling. The WUS may include separate fields for downlink and uplink dormant secondary cell group indicator fields. For example, a first field of the WUS may be used to indicate for the UE 115-a to switch to a downlink dormant BWP, and a second field of the WUS may be used to indicate for the UE 115-a to switch to an uplink dormant BWP. In some examples, when decoupled downlink and uplink secondary cell dormancy is configured, dormant secondary cell groups may be separately configured for downlink and uplink.

In some examples, the control signaling 205 may configure the UE 115-a for decoupled PDCCH monitoring adaptation. For example, the network entity 105-a may transmit DCI that indicates for the UE 115-a to skip monitoring of uplink DCI or downlink DCI, or both. If, for example, the UE 115-a is configured to for uplink PDCCH skipping, the UE 115-a may refrain from monitoring PDCCH for uplink DCI, or DCI which schedules the UE 115-a for uplink communications, for a configured duration. With decoupled PDCCH monitoring adaptation, the UE 115-a may be separately indicated to skip PDCCH monitoring for uplink DCI and downlink DCI. In some examples, DCI (e.g., scheduling DCI) may include separate fields or codepoints to indicate downlink DCI skipping, uplink DCI skipping, or both. For example, separate fields or codepoints may be allocated for downlink DCI and uplink DCI skipping indications. In some examples, different DCI formats may be used to indicate downlink DCI skipping and uplink DCI skipping. For example, downlink DCI may indicate downlink PDCCH skipping, and uplink DCI may indicate uplink PDCCH skipping. In some examples, separate PDCCH skipping durations may be configured for downlink PDCCH skipping and uplink PDCCH skipping, where the skipping durations may be the same or different for downlink and uplink PDCCH skipping. In some examples, a duration for downlink PDCCH skipping and a duration for uplink PDCCH skipping may be configured via RRC signaling.

In some examples, downlink PDCCH search space sets and uplink PDCCH search space sets may be decoupled, and search space set group switching may be separately applied to downlink search space set groups and uplink search space set groups. For example, the control signaling 205 may configure the UE 115 to switch a downlink search space set group and not an uplink search space set group or vice versa. DCI (e.g., scheduling DCI) may include separate fields or codepoints for a downlink search space set group switching indication and an uplink search space set group switching indication. For example, separate fields or codepoints may be allocated for downlink search space set group and uplink search space set group switching indications. In some examples, different DCI formats may be used to indicate downlink search space set group switching and uplink search space set group switching. For example, downlink DCI may include a downlink search space set group switching indication, and uplink DCI may include an uplink search space set group switching indication. In some examples, separate search space set group configurations and timer operation may be applied for downlink and uplink.

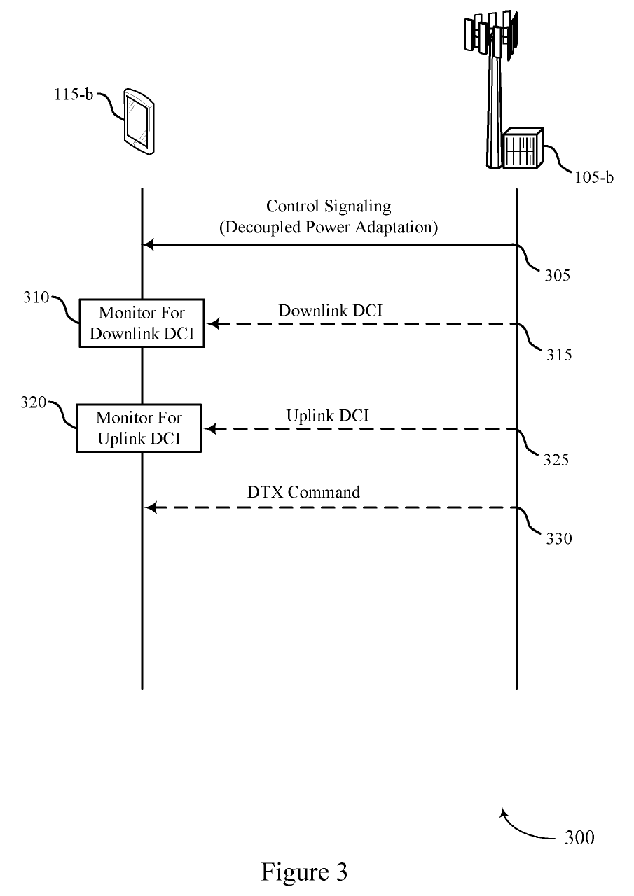

FIG. 3 shows an example of a process flow 300 that supports decoupled downlink and uplink power adaptation. The process flow 300 may implement aspects of a wireless communication system 100 and a signaling diagram 200. For example, the process flow 300 may be implemented by a UE 115-b or a network entity 105-b, or both, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

At 305, the network entity 105-b may transmit control signaling that indicates one or more decoupled power adaptation configurations to the UE 115-b. For example, the UE 115-b may receive control signaling that separately configures uplink power adaptation and downlink power adaptation. For example, control signaling may configure the UE 115-b for decoupled DRX and DTX operation, decoupled downlink and uplink secondary cell dormancy, or decoupled PDCCH monitoring adaptation, or any combination thereof, as described with reference to FIG. 2.

In some examples, the control signaling may indicate a configuration that separately configures DRX operation and DTX operation at the UE 115-b. The configuration may indicate a set of DRX parameters for the DRX operation and a set of DTX parameters for the DTX operation. For example, the set of DTX parameters may include a first parameter that indicates a first duration of a DTX on duration timer, a second parameter that indicates a second duration of a DTX inactivity timer, a third parameter that indicates a third duration of a DTX retransmission timer, a fourth parameter that indicates a fourth duration of a DTX round trip time timer, or any combination thereof. The set of DRX parameters may include a fifth parameter that indicates a fifth duration of a DRX on duration timer, a sixth parameter that indicates a sixth duration of a DRX inactivity timer, a seventh parameter that indicates a seventh duration of a DRX retransmission timer, an eight parameter that indicates an eighth duration of a DRX feedback round trip time timer, or any combination thereof. In some examples, the set of DTX parameters and the set of DRX parameters include one or more common parameters including a periodicity parameter (e.g., periodicity of DRX cycle or DTX cycle), timing offset parameter, short cycle timer parameter, or any combination thereof.

Additionally, or alternatively, the control signaling may correspond to decoupled downlink and uplink secondary cell dormancy. For example, the control signaling may configure a first duration associated with skipping monitoring PDCCH for uplink DCI a second duration associated with skipping monitoring PDCCH for downlink DCI.

At 310, the UE 115-b may monitor for DCI that schedules downlink communication according to a downlink power adaptation configuration. For example, the UE 115-b may monitor for DCI that schedules a downlink communication (e.g., downlink DCI) in accordance with the set of DRX parameters for the DRX operation. At 320, the UE 115-b may monitor for DCI that schedules uplink communication according to an uplink power adaptation configuration. For example, the UE 115-b may monitor for DCI that schedules uplink communication (e.g., and uplink DCI) in accordance with the set of DTX parameters for the DTX operation.

At 315, the network entity 105-b may transmit downlink DCI to the UE 115-b in accordance with the downlink power adaptation configuration. For example, the network entity 105-b may transmit the downlink DCI during an on duration of the DRX cycle of the UE 115-b. The UE 115-b may not reset any DTX timers based on receiving the downlink DCI. At 325, the network entity 105-b may transmit uplink DCI to the UE 115-b in accordance with the uplink power adaptation configuration. For example, the network entity 105-b may transmit the uplink DCI while an on duration timer of the DTX cycle is active. The UE 115-b may start a DTX inactivity timer based on reception of the uplink DCI. The UE 115-b may not start, restart, or reset DRX timers based on receiving the uplink DCI.

In some examples, the network entity 105-b may transmit a DTX command to the UE 115-b at 330. For example, the DTX command may be a MAC CE which forces the UE 115-b to stop a DTX on duration timer or a DTX inactivity timer, or both. The UE 115-b may stop the DTX on duration timer or the DTX inactivity timer based on receiving the DTX command.

In some examples, the downlink DCI received at 315 may configure the UE 115-b to switch to a dormant downlink BWP. The UE 115-b may switch to a downlink dormant BWP and may not monitor PDCCH or receive PDSCH signaling while switched to the dormant downlink BWP. In some examples, the UE 115-b may communicate uplink signaling via an active uplink BWP while the UE 115-b is switched to the downlink dormant BWP. Additionally, or alternatively, the uplink DCI at 325 may configure the UE 115-b to switch to an uplink dormant BWP. The UE 115-b may not report CSI or transmit SRS, PUCCH signaling, PUSCH signaling, or RACH signaling while switched to the uplink dormant BWP. In some examples, the UE 115-b may communicate downlink signaling via an active downlink BWP while the UE 115-b is switched to the uplink dormant BWP.

In some examples, the downlink DCI received at 315 may configure the UE 115-b to skip monitoring PDCCH for uplink DCI or downlink DCI, or both. For example, the UE 115-b may skip monitoring PDCCH for downlink DCI for a first duration based on receiving the downlink DCI. Additionally, or alternatively, the UE 115-b may skip monitoring PDCCH for uplink DCI for a second duration based on receiving the downlink DCI. In some examples, the downlink DCI received at 315 may configure the UE 115-b to skip monitoring PDCCH for downlink DCI, or the uplink DCI received at 325 may configure the UE 115-b to skip monitoring PDCCH for uplink DCI, or both. In some examples, the uplink DCI or the downlink DCI, or both, may configure the UE 115-b for downlink search space set group switching or uplink search space set group switching, or both. In some examples, the control signaling received at 305 may indicate separate configurations for uplink search space set groups and downlink search space set groups. For example, the control signaling may indicate separate timers or timer operation which may be applied for downlink and uplink search space set groups or search space set group switching.

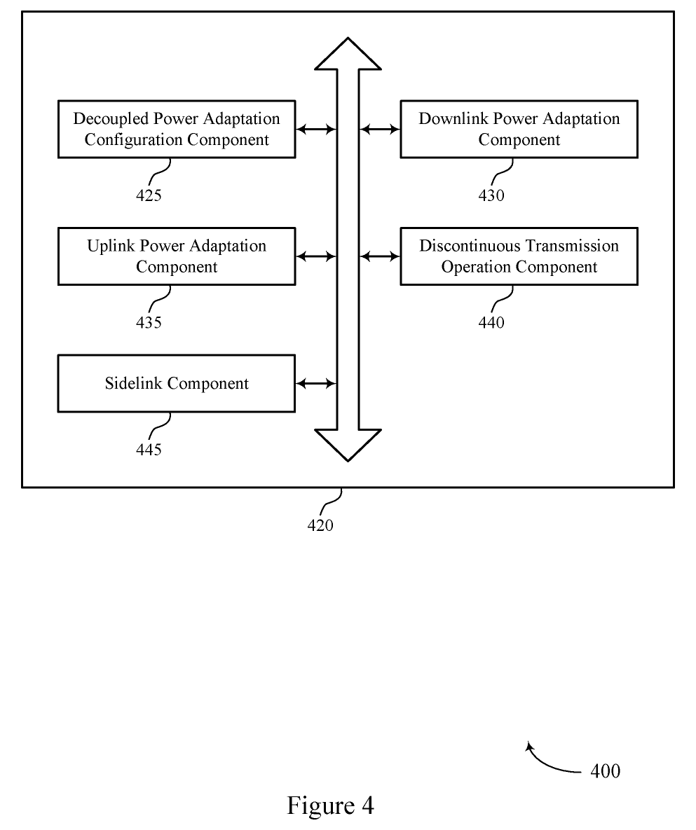

FIG. 4 shows an example of a processing system 420 that supports decoupled downlink and uplink power adaptation. A processing system 420 may be an example of a processing system 140 (such as of a UE 115) and may include a decoupled power adaptation configuration component 425, a downlink power adaptation component 430, an uplink power adaptation component 435, a DTX operation component 440, a sidelink component 445, or any combination thereof. A processing system 420, or various component thereof, may be an example of means for performing (such as a means for causing a UE 115 to perform) various techniques described herein.

The decoupled power adaptation configuration component 425 may be configured to cause the UE 115 to receive control signaling that indicates a configuration that separately configures DRX operation and DTX operation, the configuration indicating a set of DRX parameters for the DRX operation and a set of DTX parameters for the DTX operation. The downlink power adaptation component 430 may be configured to cause the UE 115 to monitor for downlink control information that schedules a downlink communication in accordance with the set of DRX parameters for the DRX operation. The uplink power adaptation component 435 may be configured to cause the UE 115 to monitor for downlink control information that schedules an uplink communication in accordance with the set of DTX parameters for the DTX operation.

In some examples, the DTX operation component 440 may be configured to cause the UE 115 to receive first downlink control information that schedules an uplink transmission while a DTX on duration timer is active. In some examples, the DTX operation component 440 may be configured to cause the UE 115 to start a DTX inactivity timer based on reception of the first downlink control information, where the set of DTX parameters includes a first parameter that indicates a first duration value for the DTX on duration timer and a second parameter that indicates a second duration value for the DTX inactivity timer.

In some examples, the DTX operation component 440 may be configured to cause the UE 115 to start a DTX round trip time timer or a DTX retransmission timer, or both, based on reception of the first downlink control information, where the set of DTX parameters includes a third parameter that indicates a third duration value for the DTX round trip time timer or a fourth parameter that indicates a fourth duration value for the DTX retransmission timer, or both.

In some examples, the configuration indicates that starting or restarting of one or more DRX timers is independent of reception of the first downlink control information that schedules the uplink transmission.

In some examples, the DTX operation component 440 may be configured to cause the UE 115 to start a DTX timer, where the set of DTX parameters includes a first parameter that indicates a duration value for the DTX timer. In some examples, the DTX operation component 440 may be configured to cause the UE 115 to receive a control message that indicates to stop the DTX timer. In some examples, the DTX operation component 440 may be configured to cause the UE 115 to stop the DTX timer based on the control message.

In some examples, the set of DTX parameters includes a first parameter that indicates a first duration of a DTX on duration timer, a second parameter that indicates a second duration of a DTX inactivity timer, a third parameter that indicates a third duration of a DTX retransmission timer, a fourth parameter that indicates a fourth duration of a DTX round trip time timer, or any combination thereof. In some examples, the set of DRX parameters includes a fifth parameter that indicates a fifth duration of a DRX on duration timer, a sixth parameter that indicates a sixth duration of a DRX inactivity timer, a seventh parameter that indicates a seventh duration of a DRX retransmission timer, an eight parameter that indicates an eighth duration of a DRX feedback round trip time timer, or any combination thereof.

In some examples, the set of DTX parameters and the set of DRX parameters include one or more common parameters including a periodicity parameter, timing offset parameter, short cycle timer parameter, or any combination thereof.

In some examples, the control signaling indicates a set of sidelink DRX parameters that is separate from the set of DTX parameters.

In some examples, the sidelink component 445 may be configured to cause the UE 115 to communicate sidelink signaling in accordance with the set of DTX parameters.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for reduced processing and reduced power consumption.

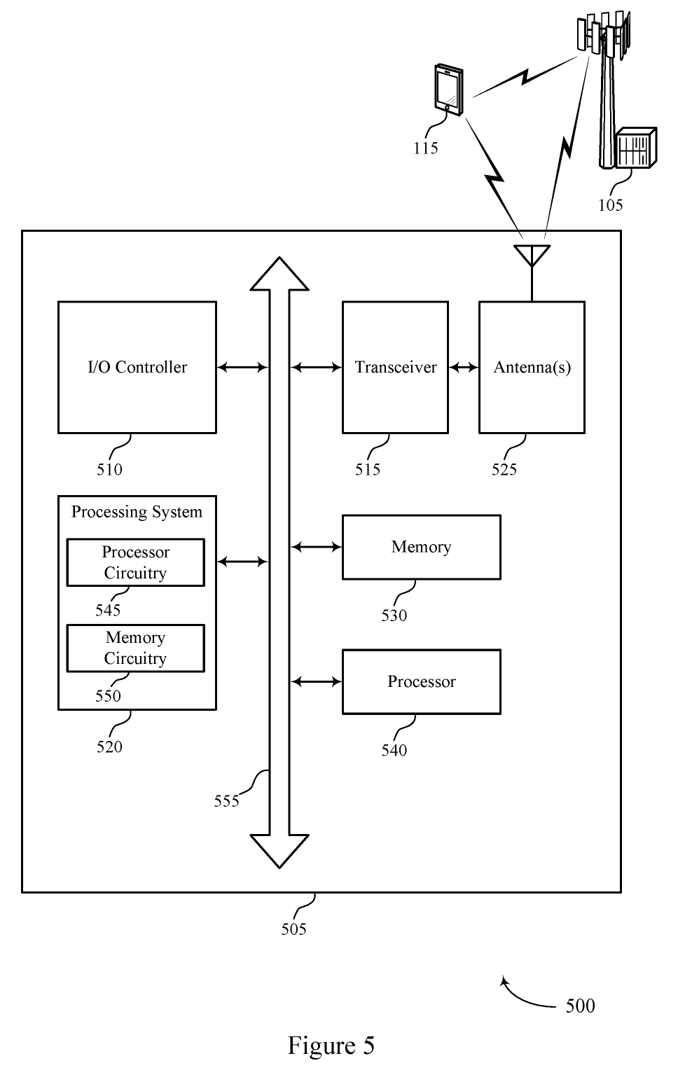

FIG. 5 shows an example of a system 500 including a device 505 that supports decoupled downlink and uplink power adaptation. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 400. For example, the processing system 520 may include processor circuitry 545 and memory circuitry 550 that stores code, and may be configured to cause the device 505 to perform operations that support decoupled downlink and uplink power adaptation. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for improved communication reliability, reduced latency, and reduced power consumption.

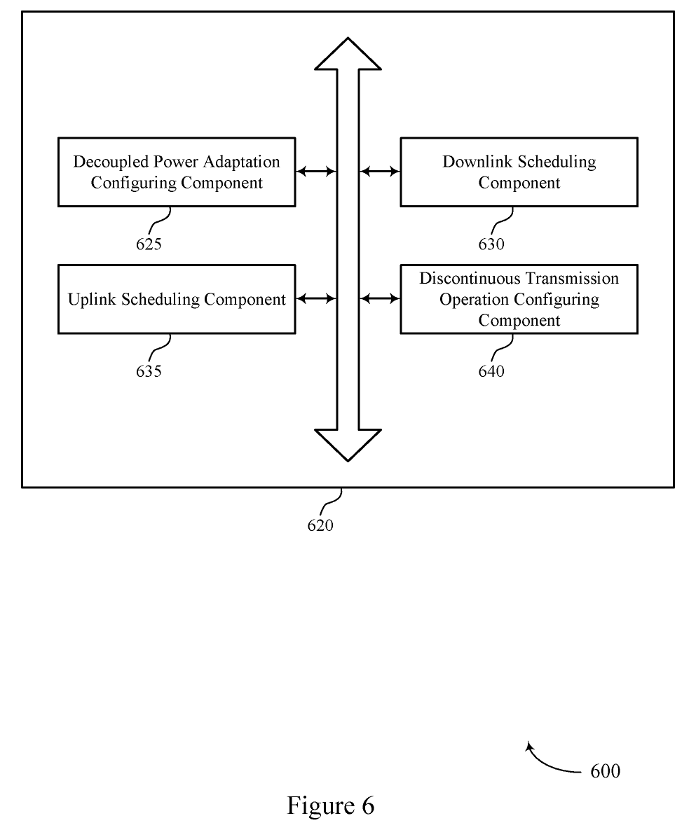

FIG. 6 shows an example of a processing system 620 that supports decoupled downlink and uplink power adaptation. A processing system 620 may be an example of a processing system 145 (such as network entity 105) and may include a decoupled power adaptation configuring component 625, a downlink scheduling component 630, an uplink scheduling component 635, a DTX operation configuring component 640, or any combination thereof. A processing system 620, or various component thereof, may be an example of means for performing (such as a means for causing a network entity 105 to perform) various techniques described herein.

The decoupled power adaptation configuring component 625 may be configured to cause the network entity 105 to output control signaling that indicates a configuration that separately configures DRX operation and DTX operation for a UE, the configuration indicating a set of DRX parameters for the DRX operation and a set of DTX parameters for the DTX operation. The downlink scheduling component 630 may be configured to cause the network entity 105 to output downlink control information that schedules the UE for downlink communications in accordance with the set of DRX parameters for the DRX operation. The uplink scheduling component 635 may be configured to cause the network entity 105 to output downlink control information that schedules the UE for uplink communications in accordance with the set of DTX parameters for the DTX operation.

In some examples, the uplink scheduling component 635 may be configured to cause the network entity 105 to output first downlink control information that schedules an uplink transmission while a DTX on duration timer is active, where the set of DTX parameters includes a first parameter that indicates a first duration value for the DTX on duration timer.

In some examples, the DTX operation configuring component 640 may be configured to cause the network entity 105 to output a control message that indicates for the UE to stop a DTX timer where the set of DTX parameters includes a first parameter that indicates a duration value for the DTX timer.

In some examples, the set of DTX parameters includes a first parameter that indicates a first duration of a DTX on duration timer, a second parameter that indicates a second duration of a DTX inactivity timer, a third parameter that indicates a third duration of a DTX retransmission timer, a fourth parameter that indicates a fourth duration of a DTX round trip time timer, or any combination thereof. In some examples, the set of DRX parameters includes a fifth parameter that indicates a fifth duration of a DRX on duration timer, a sixth parameter that indicates a sixth duration of a DRX inactivity timer, a seventh parameter that indicates a seventh duration of a DRX retransmission timer, an eight parameter that indicates an eighth duration of a DRX feedback round trip time timer, or any combination thereof.

In some examples, the set of DTX parameters and the set of DRX parameters include one or more common parameters including a periodicity parameter, timing offset parameter, short cycle timer parameter, or any combination thereof.

In some examples, the control signaling indicates a set of sidelink DRX parameters that is separate from the set of DTX parameters.

A processing system 620 may include or be an example of one or more chips, SoCs, chipsets, packages, components, or devices that individually or collectively constitute or include a processing system. A processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 620 for operation in a processing system 620 as described herein, the processing system 620 may support techniques for reduced power consumption and more efficient utilization of communication resources.

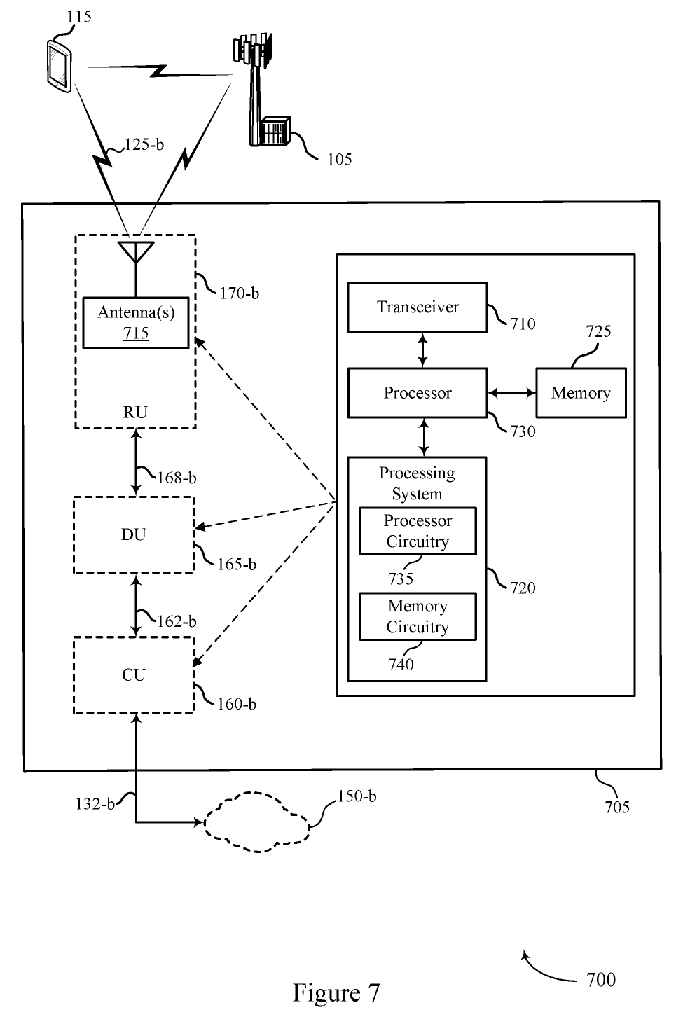

FIG. 7 shows an example of a system 700 including a device 705 that supports decoupled downlink and uplink power adaptation. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communication, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links, and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communication via one or more communication links (such as a communication link 125-b, a backhaul link 132-b, a midhaul link 162-b, fronthaul link 168-b).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as CU 160-b, DU 165-b, RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as X2 interface, Xn interface) to provide communication between network entities 105.

The processing system 720 may be an example of a processing system 145 or a processing system 600. For example, the processing system 720 may include processor circuitry 735 and memory circuitry 740 that stores code, and the processing system 720 may be configured to cause the device 705 to perform operations that support decoupled downlink and uplink power adaptation. Although the processing system 720 is illustrated as a separate component, which may involve a separate chip, chipset, or other module, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, may support techniques for decoupling downlink and uplink power adaptation mechanisms, allowing each channel to be optimized independently based on channel conditions and device requirements. This may provide reduced overall power consumption.

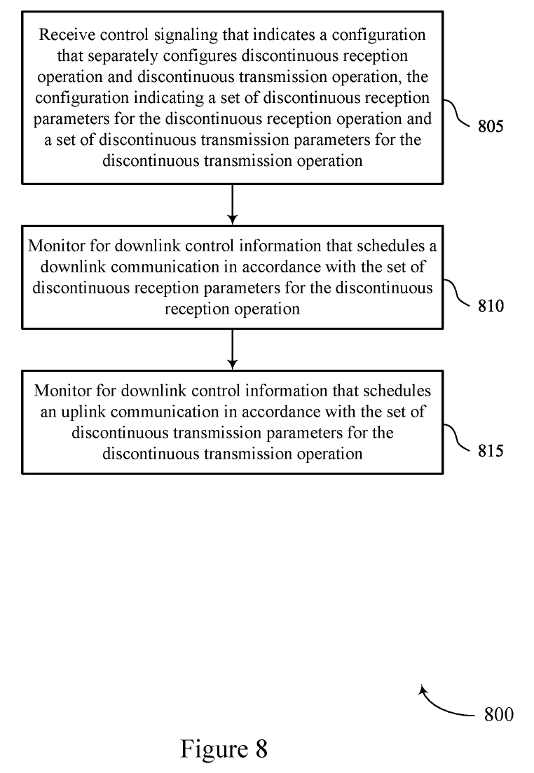

FIG. 8 shows an example of a method 800 that supports decoupled downlink and uplink power adaptation. Operations of the method 800 may be performed by a UE or its components (such as using a processing system configured to cause the UE 115 to perform one or more of the operations) as described herein.

At 805, the method may include receiving control signaling that indicates a configuration that separately configures DRX operation and DTX operation, the configuration indicating a set of DRX parameters for the DRX operation and a set of DTX parameters for the DTX operation. In some examples, aspects of the operations of 805 may be performed by a decoupled power adaptation configuration component 425.

At 810, the method may include monitoring for downlink control information that schedules a downlink communication in accordance with the set of DRX parameters for the DRX operation. In some examples, aspects of the operations of 810 may be performed by a downlink power adaptation component 430.

At 815, the method may include monitoring for downlink control information that schedules an uplink communication in accordance with the set of DTX parameters for the DTX operation. In some examples, aspects of the operations of 815 may be performed by an uplink power adaptation component 435.

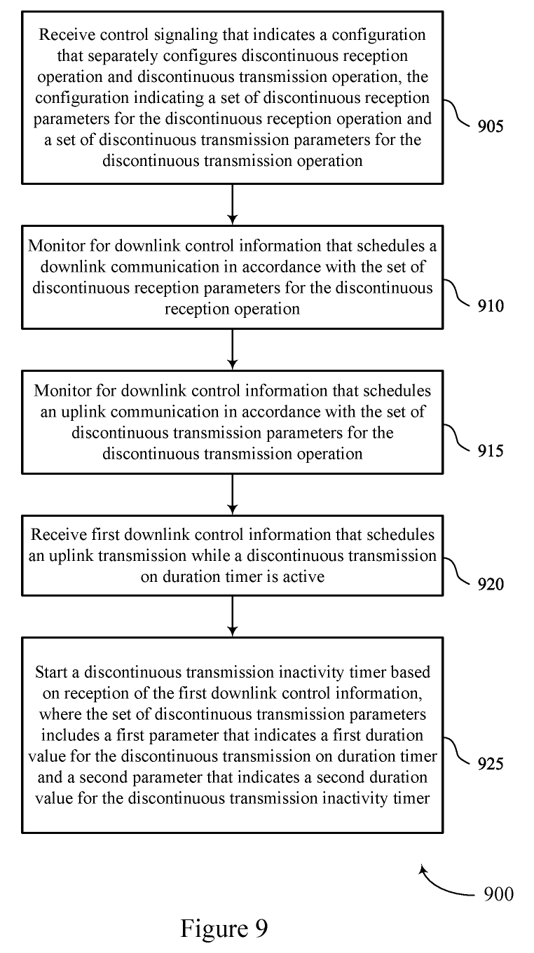

FIG. 9 shows an example of a method 900 that supports decoupled downlink and uplink power adaptation. Operations of the method 900 may be performed by a UE or its components (such as using a processing system configured to cause the UE 115 to perform one or more of the operations) as described herein.

At 905, the method may include receiving control signaling that indicates a configuration that separately configures DRX operation and DTX operation, the configuration indicating a set of DRX parameters for the DRX operation and a set of DTX parameters for the DTX operation. In some examples, aspects of the operations of 905 may be performed by a decoupled power adaptation configuration component 425.

At 910, the method may include monitoring for downlink control information that schedules a downlink communication in accordance with the set of DRX parameters for the DRX operation. In some examples, aspects of the operations of 910 may be performed by a downlink power adaptation component 430.

At 915, the method may include monitoring for downlink control information that schedules an uplink communication in accordance with the set of DTX parameters for the DTX operation. In some examples, aspects of the operations of 915 may be performed by an uplink power adaptation component 435.

At 920, the method may include receiving first downlink control information that schedules an uplink transmission while a DTX on duration timer is active. In some examples, aspects of the operations of 920 may be performed by a DTX operation component 440.

At 925, the method may include starting a DTX inactivity timer based on reception of the first downlink control information, where the set of DTX parameters includes a first parameter that indicates a first duration value for the DTX on duration timer and a second parameter that indicates a second duration value for the DTX inactivity timer. In some examples, aspects of the operations of 925 may be performed by a DTX operation component 440.

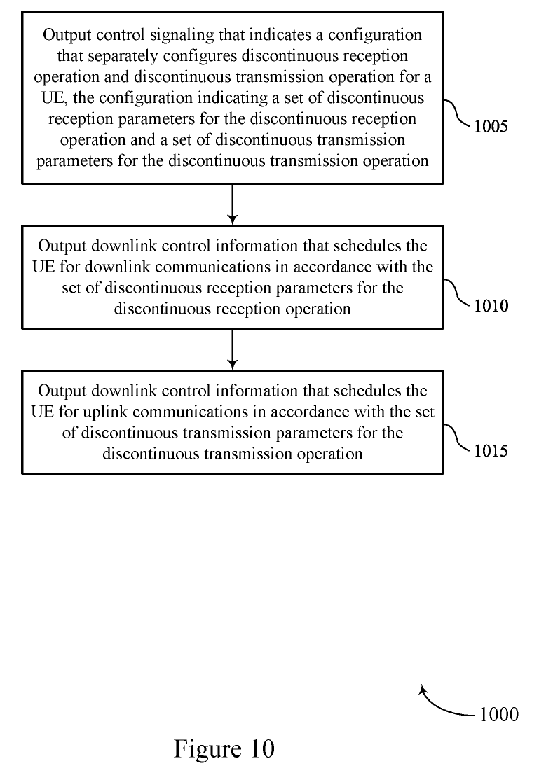

FIG. 10 shows an example of a method 1000 that supports decoupled downlink and uplink power adaptation. Operations of the method 1000 may be performed by a network entity 105 or its components (such as using a processing system configured to cause the network entity to perform one or more operations) as described herein.

At 1005, the method may include outputting control signaling that indicates a configuration that separately configures DRX operation and DTX operation for a UE, the configuration indicating a set of DRX parameters for the DRX operation and a set of DTX parameters for the DTX operation. In some examples, aspects of the operations of 1005 may be performed by a decoupled power adaptation configuring component 625.

At 1010, the method may include outputting downlink control information that schedules the UE for downlink communications in accordance with the set of DRX parameters for the DRX operation. In some examples, aspects of the operations of 1010 may be performed by a downlink scheduling component 630.

At 1015, the method may include outputting downlink control information that schedules the UE for uplink communications in accordance with the set of DTX parameters for the DTX operation. In some examples, aspects of the operations of 1015 may be performed by an uplink scheduling component 635.

Implementation examples are described in the following numbered clauses:

Aspect 1: A method for wireless communications at a UE, comprising: receiving control signaling that indicates a configuration that separately configures DRX operation and DTX operation, the configuration indicating a set of DRX parameters for the DRX operation and a set of DTX parameters for the DTX operation; monitoring for downlink control information that schedules a downlink communication in accordance with the set of DRX parameters for the DRX operation; and monitoring for downlink control information that schedules an uplink communication in accordance with the set of DTX parameters for the DTX operation.

Aspect 2: The method of aspect 1, further comprising: receiving first downlink control information that schedules an uplink transmission while a DTX on duration timer is active; and starting a DTX inactivity timer based at least in part on reception of the first downlink control information, wherein the set of DTX parameters comprises a first parameter that indicates a first duration value for the DTX on duration timer and a second parameter that indicates a second duration value for the DTX inactivity timer.

Aspect 3: The method of aspect 2, further comprising: starting a DTX round trip time timer or a DTX retransmission timer, or both, based at least in part on reception of the first downlink control information, wherein the set of DTX parameters comprises a third parameter that indicates a third duration value for the DTX round trip time timer or a fourth parameter that indicates a fourth duration value for the DTX retransmission timer, or both.

Aspect 4: The method of any of aspects 2 through 3, wherein the configuration indicates that starting or restarting of one or more DRX timers is independent of reception of the first downlink control information that schedules the uplink transmission.

Aspect 5: The method of any of aspects 1 through 4, further comprising: starting a DTX timer, wherein the set of DTX parameters comprises a first parameter that indicates a duration value for the DTX timer; receiving a control message that indicates to stop the DTX timer; and stopping the DTX timer based at least in part on the control message.

Aspect 6: The method of any of aspects 1 through 5, wherein the set of DTX parameters comprises a first parameter that indicates a first duration of a DTX on duration timer, a second parameter that indicates a second duration of a DTX inactivity timer, a third parameter that indicates a third duration of a DTX retransmission timer, a fourth parameter that indicates a fourth duration of a DTX round trip time timer, or any combination thereof; and the set of DRX parameters comprises a fifth parameter that indicates a fifth duration of a DRX on duration timer, a sixth parameter that indicates a sixth duration of a DRX inactivity timer, a seventh parameter that indicates a seventh duration of a DRX retransmission timer, an eight parameter that indicates an eighth duration of a DRX feedback round trip time timer, or any combination thereof.

Aspect 7: The method of any of aspects 1 through 6, wherein the set of DTX parameters and the set of DRX parameters comprise one or more common parameters including a periodicity parameter, timing offset parameter, short cycle timer parameter, or any combination thereof.

Aspect 8: The method of any of aspects 1 through 7, wherein the control signaling indicates a set of sidelink DRX parameters that is separate from the set of DTX parameters.

Aspect 9: The method of any of aspects 1 through 8, further comprising: communicating sidelink signaling in accordance with the set of DTX parameters.

Aspect 10: A method for wireless communications at a network entity, comprising: outputting control signaling that indicates a configuration that separately configures DRX operation and DTX operation for a UE, the configuration indicating a set of DRX parameters for the DRX operation and a set of DTX parameters for the DTX operation; outputting downlink control information that schedules the UE for downlink communications in accordance with the set of DRX parameters for the DRX operation; and outputting downlink control information that schedules the UE for uplink communications in accordance with the set of DTX parameters for the DTX operation.

Aspect 11: The method of aspect 10, further comprising: outputting first downlink control information that schedules an uplink transmission while a DTX on duration timer is active, wherein the set of DTX parameters comprises a first parameter that indicates a first duration value for the DTX on duration timer.

Aspect 12: The method of any of aspects 10 through 11, further comprising: outputting a control message that indicates for the UE to stop a DTX timer wherein the set of DTX parameters comprises a first parameter that indicates a duration value for the DTX timer.

Aspect 13: The method of any of aspects 10 through 12, wherein the set of DTX parameters comprises a first parameter that indicates a first duration of a DTX on duration timer, a second parameter that indicates a second duration of a DTX inactivity timer, a third parameter that indicates a third duration of a DTX retransmission timer, a fourth parameter that indicates a fourth duration of a DTX round trip time timer, or any combination thereof; and the set of DRX parameters comprises a fifth parameter that indicates a fifth duration of a DRX on duration timer, a sixth parameter that indicates a sixth duration of a DRX inactivity timer, a seventh parameter that indicates a seventh duration of a DRX retransmission timer, an eight parameter that indicates an eighth duration of a DRX feedback round trip time timer, or any combination thereof.

Aspect 14: The method of any of aspects 10 through 13, wherein the set of DTX parameters and the set of DRX parameters comprise one or more common parameters including a periodicity parameter, timing offset parameter, short cycle timer parameter, or any combination thereof.

Aspect 15: The method of any of aspects 10 through 14, wherein the control signaling indicates a set of sidelink DRX parameters that is separate from the set of DTX parameters.

Aspect 16: A UE for wireless communications, comprising a processing system that includes processor circuitry and memory circuitry that stores code, the processing system configured to cause the UE to perform a method of any of aspects 1 through 9.

Aspect 17: A UE for wireless communications, comprising at least one means for performing a method of any of aspects 1 through 9.

Aspect 18: A non-transitory computer-readable medium storing code for wireless communications, the code comprising instructions executable by one or more processors to perform a method of any of aspects 1 through 9.

Aspect 19: A network entity for wireless communications, comprising a processing system that includes processor circuitry and memory circuitry that stores code, the processing system configured to cause the network entity to perform a method of any of aspects 10 through 15.

Aspect 20: A network entity for wireless communications, comprising at least one means for performing a method of any of aspects 10 through 15.

Aspect 21: A non-transitory computer-readable medium storing code for wireless communications, the code comprising instructions executable by one or more processors to perform a method of any of aspects 10 through 15.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling that indicates a configuration that separately configures discontinuous reception operation and discontinuous transmission operation, the configuration indicating a set of discontinuous reception parameters for the discontinuous reception operation and a set of discontinuous transmission parameters for the discontinuous transmission operation;
monitor for downlink control information that schedules a downlink communication in accordance with the set of discontinuous reception parameters for the discontinuous reception operation; and
monitor for downlink control information that schedules an uplink communication in accordance with the set of discontinuous transmission parameters for the discontinuous transmission operation.

2. The UE of claim 1, wherein the processing system is further configured to cause the UE to:
receive first downlink control information that schedules an uplink transmission while a discontinuous transmission on duration timer is active; and
start a discontinuous transmission inactivity timer based at least in part on reception of the first downlink control information, wherein the set of discontinuous transmission parameters comprises a first parameter that indicates a first duration value for the discontinuous transmission on duration timer and a second parameter that indicates a second duration value for the discontinuous transmission inactivity timer.

3. The UE of claim 2, wherein the processing system is further configured to cause the UE to:
start a discontinuous transmission round trip time timer or a discontinuous transmission retransmission timer, or both, based at least in part on reception of the first downlink control information, wherein the set of discontinuous transmission parameters comprises a third parameter that indicates a third duration value for the discontinuous transmission round trip time timer or a fourth parameter that indicates a fourth duration value for the discontinuous transmission retransmission timer, or both.

4. The UE of claim 2, wherein the configuration indicates that starting or restarting of one or more discontinuous reception timers is independent of reception of the first downlink control information that schedules the uplink transmission.

5. The UE of claim 1, wherein the processing system is further configured to cause the UE to:
start a discontinuous transmission timer, wherein the set of discontinuous transmission parameters comprises a first parameter that indicates a duration value for the discontinuous transmission timer;
receive a control message that indicates to stop the discontinuous transmission timer; and
stop the discontinuous transmission timer based at least in part on the control message.

6. The UE of claim 1, wherein:
the set of discontinuous transmission parameters comprises a first parameter that indicates a first duration of a discontinuous transmission on duration timer, a second parameter that indicates a second duration of a discontinuous transmission inactivity timer, a third parameter that indicates a third duration of a discontinuous transmission retransmission timer, a fourth parameter that indicates a fourth duration of a discontinuous transmission round trip time timer, or any combination thereof; and
the set of discontinuous reception parameters comprises a fifth parameter that indicates a fifth duration of a discontinuous reception on duration timer, a sixth parameter that indicates a sixth duration of a discontinuous reception inactivity timer, a seventh parameter that indicates a seventh duration of a discontinuous reception retransmission timer, an eight parameter that indicates an eighth duration of a discontinuous reception feedback round trip time timer, or any combination thereof.

7. The UE of claim 1, wherein the set of discontinuous transmission parameters and the set of discontinuous reception parameters comprise one or more common parameters including a periodicity parameter, timing offset parameter, short cycle timer parameter, or any combination thereof.

8. The UE of claim 1, wherein the control signaling indicates a set of sidelink discontinuous reception parameters that is separate from the set of discontinuous transmission parameters.

9. The UE of claim 1, wherein the processing system is further configured to cause the UE to:
communicate sidelink signaling in accordance with the set of discontinuous transmission parameters.

10. A network entity, comprising:
a processing system that includes processor circuitry and memory circuitry that stores code, the processing system configured to cause the network entity to:
output control signaling that indicates a configuration that separately configures discontinuous reception operation and discontinuous transmission operation for a user equipment (UE), the configuration indicating a set of discontinuous reception parameters for the discontinuous reception operation and a set of discontinuous transmission parameters for the discontinuous transmission operation;
output downlink control information that schedules the UE for downlink communications in accordance with the set of discontinuous reception parameters for the discontinuous reception operation; and
output downlink control information that schedules the UE for uplink communications in accordance with the set of discontinuous transmission parameters for the discontinuous transmission operation.

11. The network entity of claim 10, wherein the processing system is further configured to cause the network entity to:
output first downlink control information that schedules an uplink transmission while a discontinuous transmission on duration timer is active, wherein the set of discontinuous transmission parameters comprises a first parameter that indicates a first duration value for the discontinuous transmission on duration timer.

12. The network entity of claim 10, wherein the processing system is further configured to cause the network entity to:
output a control message that indicates for the UE to stop a discontinuous transmission timer wherein the set of discontinuous transmission parameters comprises a first parameter that indicates a duration value for the discontinuous transmission timer.

13. The network entity of claim 10, wherein:
the set of discontinuous transmission parameters comprises a first parameter that indicates a first duration of a discontinuous transmission on duration timer, a second parameter that indicates a second duration of a discontinuous transmission inactivity timer, a third parameter that indicates a third duration of a discontinuous transmission retransmission timer, a fourth parameter that indicates a fourth duration of a discontinuous transmission round trip time timer, or any combination thereof; and
the set of discontinuous reception parameters comprises a fifth parameter that indicates a fifth duration of a discontinuous reception on duration timer, a sixth parameter that indicates a sixth duration of a discontinuous reception inactivity timer, a seventh parameter that indicates a seventh duration of a discontinuous reception retransmission timer, an eight parameter that indicates an eighth duration of a discontinuous reception feedback round trip time timer, or any combination thereof.

14. The network entity of claim 10, wherein the set of discontinuous transmission parameters and the set of discontinuous reception parameters comprise one or more common parameters including a periodicity parameter, timing offset parameter, short cycle timer parameter, or any combination thereof.

15. The network entity of claim 10, wherein the control signaling indicates a set of sidelink discontinuous reception parameters that is separate from the set of discontinuous transmission parameters.

16. A method for wireless communications at a user equipment (UE), comprising:
receiving control signaling that indicates a configuration that separately configures discontinuous reception operation and discontinuous transmission operation, the configuration indicating a set of discontinuous reception parameters for the discontinuous reception operation and a set of discontinuous transmission parameters for the discontinuous transmission operation;
monitoring for downlink control information that schedules a downlink communication in accordance with the set of discontinuous reception parameters for the discontinuous reception operation; and
monitoring for downlink control information that schedules an uplink communication in accordance with the set of discontinuous transmission parameters for the discontinuous transmission operation.

17. The method of claim 16, further comprising:
receiving first downlink control information that schedules an uplink transmission while a discontinuous transmission on duration timer is active; and
starting a discontinuous transmission inactivity timer based at least in part on reception of the first downlink control information, wherein the set of discontinuous transmission parameters comprises a first parameter that indicates a first duration value for the discontinuous transmission on duration timer and a second parameter that indicates a second duration value for the discontinuous transmission inactivity timer.

18. The method of claim 17, further comprising:
starting a discontinuous transmission round trip time timer or a discontinuous transmission retransmission timer, or both, based at least in part on reception of the first downlink control information, wherein the set of discontinuous transmission parameters comprises a third parameter that indicates a third duration value for the discontinuous transmission round trip time timer or a fourth parameter that indicates a fourth duration value for the discontinuous transmission retransmission timer, or both.

19. The method of claim 17, wherein the configuration indicates that starting or restarting of one or more discontinuous reception timers is independent of reception of the first downlink control information that schedules the uplink transmission.

20. The method of claim 16, further comprising:
starting a discontinuous transmission timer, wherein the set of discontinuous transmission parameters comprises a first parameter that indicates a duration value for the discontinuous transmission timer;
receiving a control message that indicates to stop the discontinuous transmission timer; and
stopping the discontinuous transmission timer based at least in part on the control message.

21. The method of claim 16, wherein:
the set of discontinuous transmission parameters comprises a first parameter that indicates a first duration of a discontinuous transmission on duration timer, a second parameter that indicates a second duration of a discontinuous transmission inactivity timer, a third parameter that indicates a third duration of a discontinuous transmission retransmission timer, a fourth parameter that indicates a fourth duration of a discontinuous transmission round trip time timer, or any combination thereof; and
the set of discontinuous reception parameters comprises a fifth parameter that indicates a fifth duration of a discontinuous reception on duration timer, a sixth parameter that indicates a sixth duration of a discontinuous reception inactivity timer, a seventh parameter that indicates a seventh duration of a discontinuous reception retransmission timer, an eight parameter that indicates an eighth duration of a discontinuous reception feedback round trip time timer, or any combination thereof.

22. The method of claim 16, wherein the set of discontinuous transmission parameters and the set of discontinuous reception parameters comprise one or more common parameters including a periodicity parameter, timing offset parameter, short cycle timer parameter, or any combination thereof.

23. The method of claim 16, wherein the control signaling indicates a set of sidelink discontinuous reception parameters that is separate from the set of discontinuous transmission parameters.

24. The method of claim 16, further comprising:
communicating sidelink signaling in accordance with the set of discontinuous transmission parameters.

25. A method for wireless communications at a network entity, comprising:
outputting control signaling that indicates a configuration that separately configures discontinuous reception operation and discontinuous transmission operation for a user equipment (UE), the configuration indicating a set of discontinuous reception parameters for the discontinuous reception operation and a set of discontinuous transmission parameters for the discontinuous transmission operation;
outputting downlink control information that schedules the UE for downlink communications in accordance with the set of discontinuous reception parameters for the discontinuous reception operation; and
outputting downlink control information that schedules the UE for uplink communications in accordance with the set of discontinuous transmission parameters for the discontinuous transmission operation.

26. The method of claim 25, further comprising:
outputting first downlink control information that schedules an uplink transmission while a discontinuous transmission on duration timer is active, wherein the set of discontinuous transmission parameters comprises a first parameter that indicates a first duration value for the discontinuous transmission on duration timer.

27. The method of claim 25, further comprising:
outputting a control message that indicates for the UE to stop a discontinuous transmission timer wherein the set of discontinuous transmission parameters comprises a first parameter that indicates a duration value for the discontinuous transmission timer.

28. The method of claim 25, wherein:
the set of discontinuous transmission parameters comprises a first parameter that indicates a first duration of a discontinuous transmission on duration timer, a second parameter that indicates a second duration of a discontinuous transmission inactivity timer, a third parameter that indicates a third duration of a discontinuous transmission retransmission timer, a fourth parameter that indicates a fourth duration of a discontinuous transmission round trip time timer, or any combination thereof; and
the set of discontinuous reception parameters comprises a fifth parameter that indicates a fifth duration of a discontinuous reception on duration timer, a sixth parameter that indicates a sixth duration of a discontinuous reception inactivity timer, a seventh parameter that indicates a seventh duration of a discontinuous reception retransmission timer, an eight parameter that indicates an eighth duration of a discontinuous reception feedback round trip time timer, or any combination thereof.

29. The method of claim 25, wherein the set of discontinuous transmission parameters and the set of discontinuous reception parameters comprise one or more common parameters including a periodicity parameter, timing offset parameter, short cycle timer parameter, or any combination thereof.

30. The method of claim 25, wherein the control signaling indicates a set of sidelink discontinuous reception parameters that is separate from the set of discontinuous transmission parameters.
